(19) United States
(12) Patent Application Publication
(10) Pub. No.: US 2010/0175300 A1
(43) Pub. Date: Jul. 15, 2010

(54) Interactive Hunting decoy/platform with changeable decoys

(76) Inventor: David Lau, SouthPort, FL (US)

Correspondence Address: David Lau, 3430 Long Road, SouthPort, FL, 32409, US

(21) Appl. No.: 12/456,376

(22) Filed: Jun. 16, 2009

Related U.S. Application Data
(60) Provisional application No. 61/204,815, filed on Jan. 13, 2009.

(51) Int. Cl. A01M 31/06

(52) U.S. Cl. 43/2

(57) ABSTRACT

An interactive, mobile decoy system uses a bent wire framed assembly with two parallel support runners which transition rearward in an 180 degree arc toward the center of gravity of the support runners and terminate at a junction block. The block joins a support mechanism with a decoy attaching point. A pull mechanism incorporates a pivoting decoy mounting point for causing a decoy mounted thereon to realistically simulate the feeding motions of game fowl in general and wild turkeys in particular, especially a strutting motion of a male and a feeding behavior of a hen.

### FIELD OF THE INVENTION

The present invention is a continuation of a previous filing, application No. 61/204,815, and relates to a portable wild game decoy form system which more realistically simulates the motions of game and fowl in general including pheasant, grouse and wild turkeys in particular and is actively controlled by the hunter or decoy operator from the security of his hide. This filing contains additional improvements to the device, and features which make it more easily and inexpensively produced. Additionally, it is obvious that that the device so described is suitable as a decoy system for many other species of game beyond fowl, including deer, hog, rabbit, squirrel, prairie dog, rat, and other varmint animals. The design of the device allows the operator to easily simulate game in distress, a recognized and proven natural attractor for many predatory species.

### BACKGROUND OF THE INVENTION

It is an object of the present invention to provide a wild turkey and many other species of game decoy platform system that presents a more realistic representation of this particular species. It is obvious that the device so described is suitable as a decoy platform for many other species of game beyond fowl, including deer, hog, rabbit, squirrel, prairie dog, rat, and other varmint animals.

Another object of the present invention is to provide better control of the simulations of the decoy. Yet, another object of the present invention is to improve the stability of the decoy platform and to improve the simulated behavior of the resulting mounted decoy, which will result in greatly improved lure results. Wild turkeys as an example are extremely wary animals with acute senses of hearing, smell, and very excellent eyesight. The male of the species is territorial in an established geographical range. Wild male turkeys are cautious in approaching another turkey whether, male or female and are known to crouch in bushes and other natural cover, making it difficult to get a clear shot. The presence of a receptive female turkey decoy (as an example) will sometimes lure an otherwise cautious male to enter an open area for purposes of mating with the hen. Accordingly, a variety of decoys have been developed to attract the male out into a more open area to lure the male into a situation where it is possible to get a clean shot.

The new decoy/platform system is advantageously lightweight and compact so as to be easily carried to the hunting site.

With a realistic decoy mounted, it also accurately represents both the physical appearance of the wild turkey; and, when deployed, exhibits the natural motion of the game species. The motion of a decoy is at least as important to a successful lure as the shape and marking of the decoy body. This is particularly true of game animals such as turkeys, which are very sensitive to their surroundings.

### PRIOR ART

Decoys are simulated game used by hunters in hopes of luring game, such as turkeys, deer, hog, prairie dog, squirrel, and rat within shooting range. This new device is a mobile sled/platform system which incorporates interactive user control, making it able to more effectively simulate the games natural behavior and movement in the field. The prior art does not provide realistic representations of the wild turkey species or any game species in respect to both the behavioral activity and the natural movements of the game in its natural environment

U.S. Pat. No. 5,515,637 discloses a decoy in which the decoy body is mounted on a vertical journal axis by bearings. The idea is for ambient breeze to rotate the body on the vertical journal axis without substantial frictional resistance.

U.S. Pat. No 7,076,909 describes a sled on which a decoy form is mounted. Its range of motion is limited to simple directional change, so the motion is somewhat jerky and unnatural. Unnatural motion can be as suspicious and/or unconvincing as a lack of any motion.

U.S. Pat. No. 5,570,531 describes a bird decoy with motion associated with the head and neck. The decoy body is stationary. A one-piece head-and-neck portion is mounted to the body so that the head and neck may tilt when sufficient wind prevails.

In response to the considerations set-forth above, several decoys with movable parts have been developed, but have relied on wind to provide impetuous for the motion which may or may not accurately mimic the wild turkey in a natural setting, assuming that there is a breeze. A much better method would be to have a decoy which relied on manual fractional force and directional control, allowing a practiced operator to more accurately mimic the natural movements of the species.

U.S. Pat. No. 5,289,654 employs servo motors for movement of the head that are actuated by an RF transmitter.

U.S. Pat. No. 5,036,614 teaches rotating the entire decoy about a vertical axis on a support peg that must be driven into the ground with such rotation being accomplished manually.

A typical prior art large mammal decoy is seen in U.S. Pat. No. 5,632,110 to Roy.

A typical prior art decoy is directed to water fowl, as illustrated in U.S. Pat. No. 4,599,819 to Voges et al.

Typical bird decoys are seen in U.S. Pat. No. 4,965,953 to McKinney, U.S. Pat. No. 5,168,649 to Wright, U.S. Pat. No. 5,289,654 to Denny et al., and U.S. Pat. No. 5,459,958 to Reinke.

The preponderance of earlier issued patents relating to mutable bird decoys have to do with water fowl. As an example, U.S. Pat. No. 1,831,286 to Chelini reveals a decoy duck that is anchored to the floor of a lake and joined to the anchor with an complicated arrangement of levers, cords, and wheels to supply a decoy that will be predisposed into the wind at all times and to allow raising the decoy and causing the outstretching of the wings to simulate a live duck when it is about to raise itself from the water preparatory to flying.

Each of these devices has some advantages in aping the movement of an exacting animal genus. The mechanisms employed use a variety of devices to generate the movement. It is apparent that the purpose of the simulated movement is to dupe the game animal into believing that the decoy is a real animal, so that it will approach it.

Most of these prior art devices move in a manner to simulate simple motion. However, the prior arts are unable, in an easy and uncomplicated manner, to fully replicate the realistic movement of an animal including simulating animal behavior within a particular area.

Thus, there is a clear call for a decoy device and the related process of luring an animal that convincingly and more wholly simulates the behavior of a particular animal. Such a device would simulate natural behavior in the natural environment of the animal. Ideally, the decoy device would also do so, in a manner that is easy to convey and set up in the wild. Obviously, such a decoy would be straightforward in design, able to be operated without difficulty, would be dependable even in adverse weather and require little if any maintenance.

None of the mentioned patents accomplish the stated goal of luring wild game fowl in general and wild turkeys in particular with the simplicity, effectiveness, or low cost of the disclosed device.

### SUMMARY OF THE INVENTION

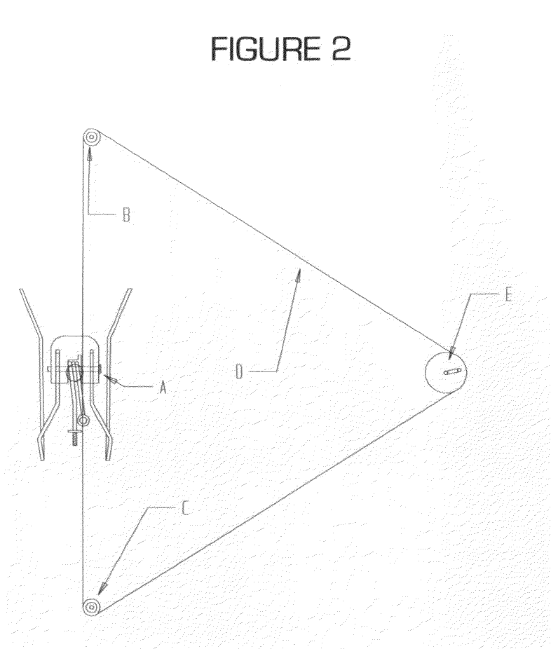

The objects of the present invention are achieved by providing a wildlife decoy form interactive platform that includes a decoy, an improved decoy platform system as shown in FIG. 2, an (A) anchor point, a (B) anchor point, a retrieval mechanism, and a series of control wires or cable to generate movement and to simulate wild game behaviors.

In one embodiment of the present invention, the wildlife decoy form is incorporated in a wild turkey decoy. In one embodiment of the present invention, the wildlife decoy form is incorporated in a wild Deer decoy.

In one embodiment of the present invention, the wildlife decoy form is incorporated in a wild Hog decoy.

In one embodiment of the present invention, the wildlife decoy form is incorporated in a wild rabbit decoy.

In one embodiment of the present invention, the wildlife decoy form is incorporated in a squirrel decoy. In one embodiment of the present invention, the wildlife decoy form is incorporated in a prairie dog decoy.

In one embodiment of the present invention, the wildlife decoy form is incorporated in a rat decoy.

In one embodiment of the present invention, the wildlife decoy form is incorporated in a wild pheasant decoy.

In one embodiment of the present invention, the wildlife decoy form is incorporated in a wild grouse decoy.

In one embodiment of the present invention, any of the wildlife decoy forms may be incorporated in a wild varmint decoy to lure predators.

In one incarnation the invention comprises a counterweighted attachment means for attaching the decoy to the base. The counterweight enables the decoy to shake slightly relative to the base. This shaking movement makes the decoy appear to be live game. This is very advantageous and it makes the decoy much more effective than fixed decoys in terms of the ability to attract predators or during mating rituals.

These and other objects of the present invention will be clarified in the description of the preferred embodiment taken with the attached figures.

### BRIEF DESCRIPTION OF THE DRAWINGS

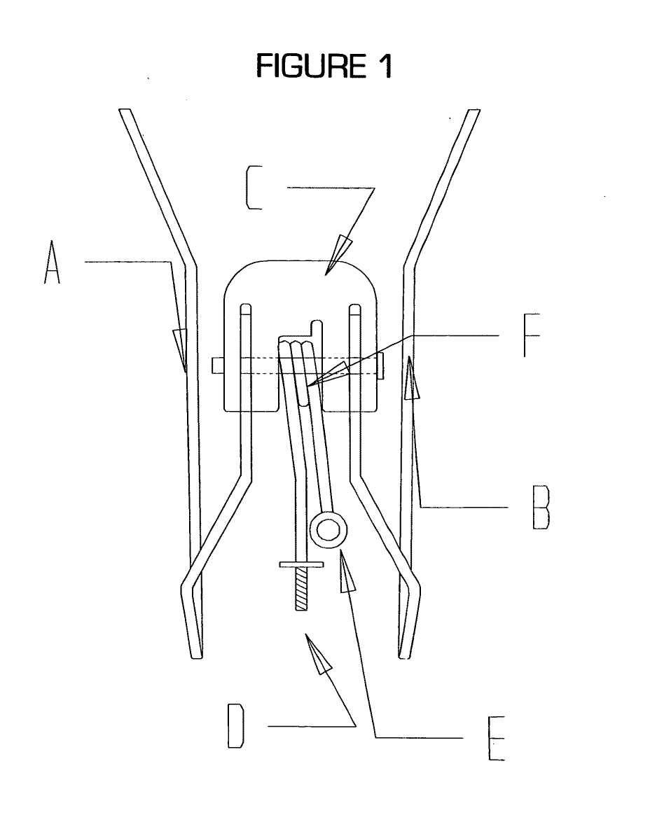

FIG. 1 is an overhead view of one iteration of a decoy/platform in accordance with the present invention in which the elements are revealed.
A. Left side decoy/platform support and spring assembly.
B. Right side decoy/platform support and spring assembly.
C. Decoy base.
D. Decoy attachment point.
E. Guide hook.

FIG. 2 is a top view of one iteration of the decoy system in deployed form, with the motion elements revealed.
A. Decoy Platform
B. Anchor Point B
C. Anchor Point A
D. Cable
E. Winder

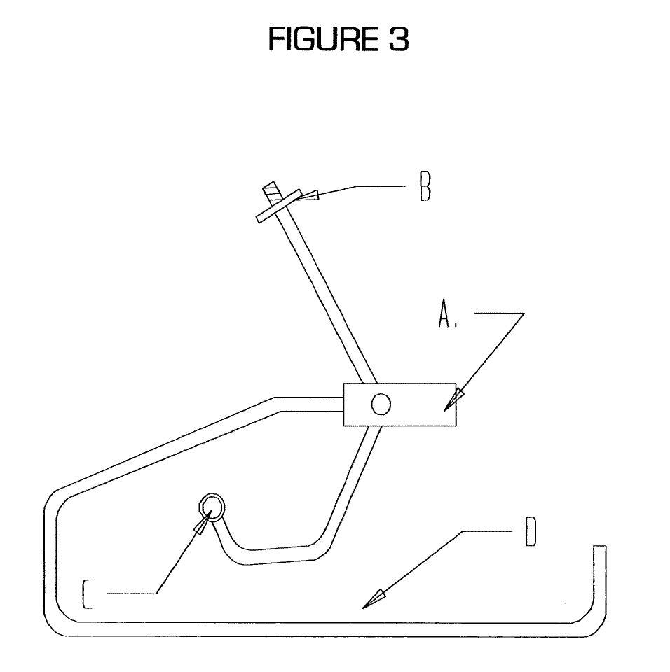

FIG. 3 is a side view of one iteration the decoy/platform in accordance with the present invention.
A. Counter weight
B. Decoy Base
C. Guide Hook
D. Right side decoy platform/spring assembly

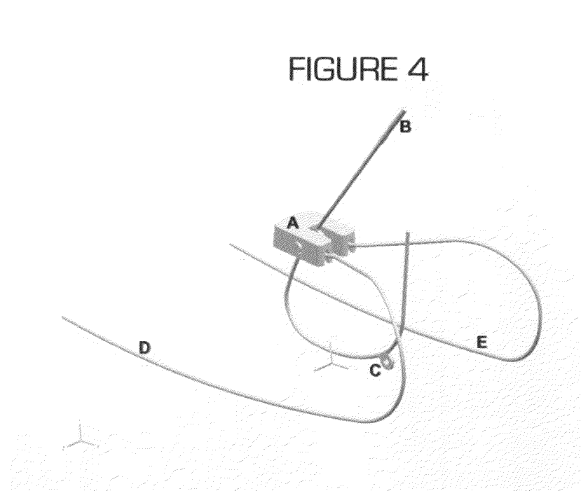

FIG. 4 is a view of the decoy/platform in accordance with a low cost of manufacturing, mass style production unit.
A. Counterweight/Junction
B. Decoy form mounting location
C. Attachment point for impetuous controller
D. Right sled/suspension component
E. Left sled/suspension component

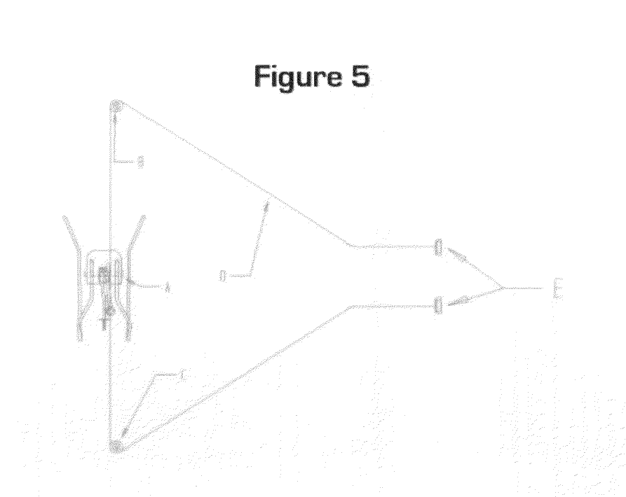

FIG. 5 is a different rendition of the Force Control mechanism which uses Right and Left hand controls for more precise control.
A. Decoy Platform
B. Anchor Point B
C. Anchor Point A
D. Cable
E. Force control mechanism

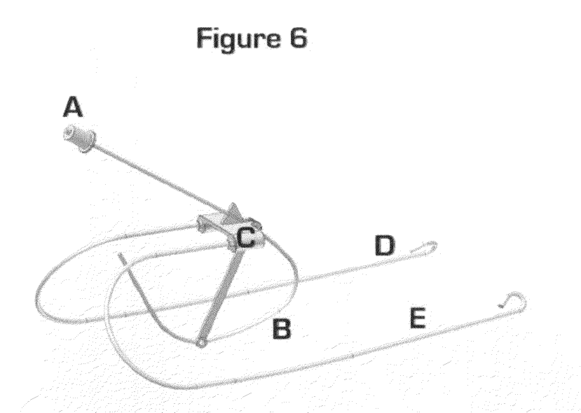

FIG. 6 reveals a production model of the device, which is easily broken down for transportation and storage, and just as easily reassembled for use in the field. It is lightweight and durable, as well as easily used. FIG. 6 reveals the production style Interactive Decoy Platform in its entirety. It is revealed to be of a modular design that breaks down for easy transport to hunting sites and yet is easily assembled in the field. Its design is superior in every respect: It is easy and inexpensive to produce using a variety of manufacturing processes, resulting in a stable, well suspended and balanced decoy platform which, through its interaction capability, is easily able to mimic natural feeding, mating and other behaviors of game animals.
A. Decoy Mounting point.
B. Pivoting interactive decoy stand
C. Pivot-sled interface
D. Left side runner
E. Right side runner

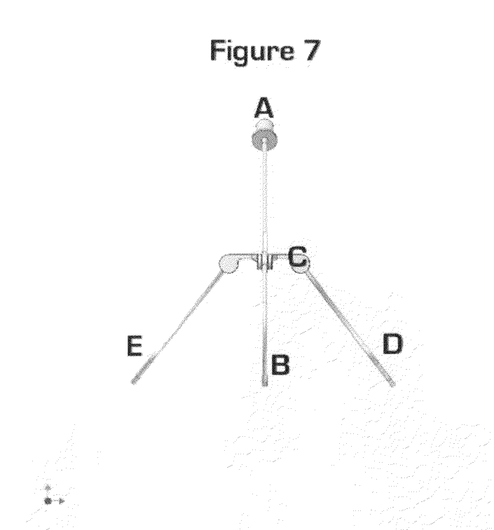

FIG. 7 reveals a rear view of the production iteration of the device, which shows the stability of the device.
A. Decoy Mounting point.
B. Pivoting interactive decoy stand
C. Pivot-sled interface
D. Left side runner
E. Right side runner

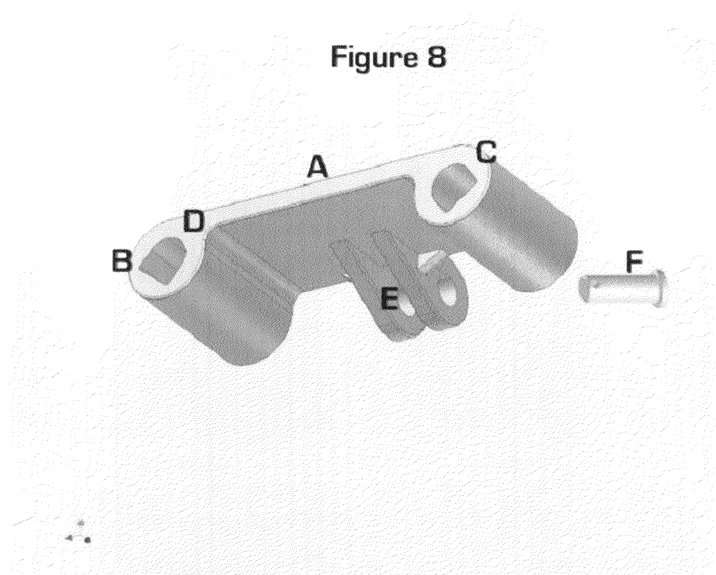

FIG. 8 shows the Interactive decoy chassis, and reveals the features.
A. Interactive Decoy Chassis
B. Right Sled Mounting Point
C. Left Sled Mounting Point
D. Top Cross Member
E. Decoy Frame Support Pivot
F. Mounting Pin

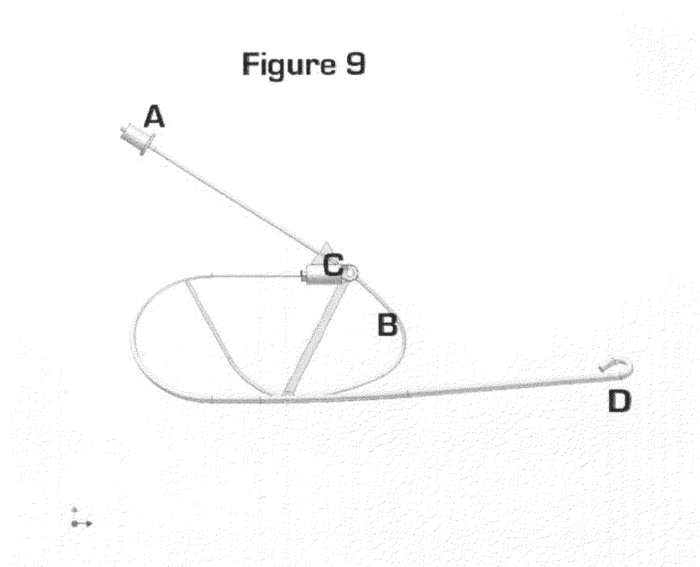

FIG. 9 is a right side view of the device with the decoy mounting point in a “feeding” position.
A. Decoy Mounting point.
B. Pivoting interactive decoy stand
C. Pivot-sled interface
D. Left side runner

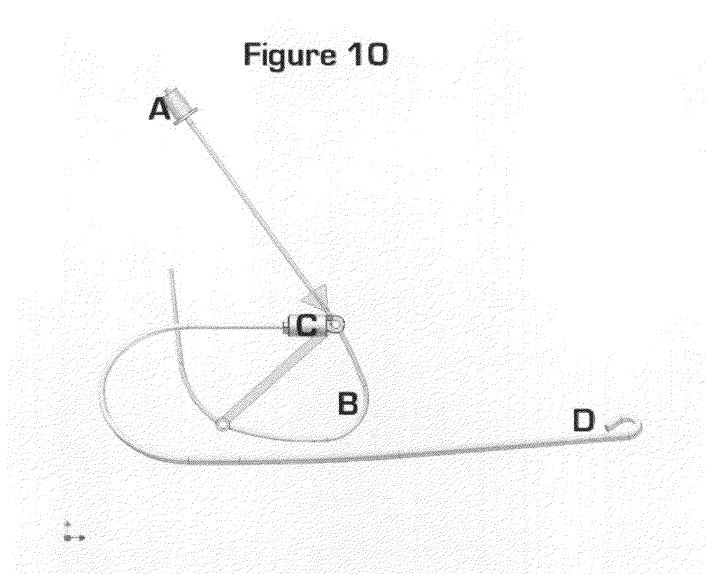

FIG. 10 is a right side view of the device with the decoy mounting point in a more upright position and is indicative of the range of natural motion the device is capable of simulating.
A. Decoy Mounting point.
B. Pivoting interactive decoy stand
C. Pivot-sled interface
D. Left side runner

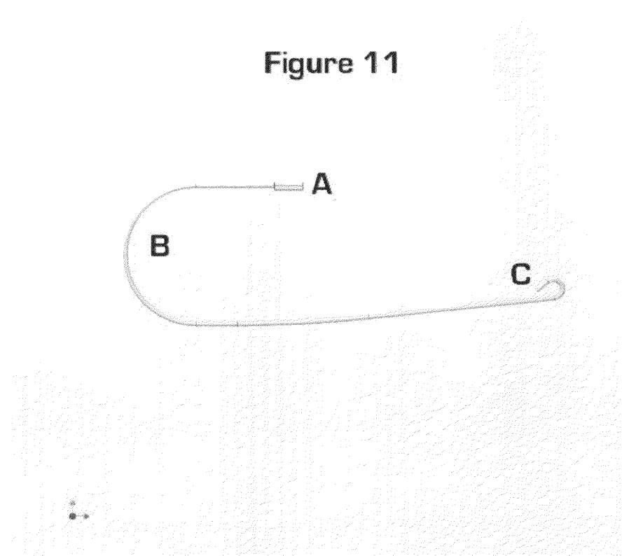

FIG. 11 details the right side runner.
A. FI Chassis mounting adapter
B. 180 bend to provide suspension
C. Trailing edge curved to reduce drag

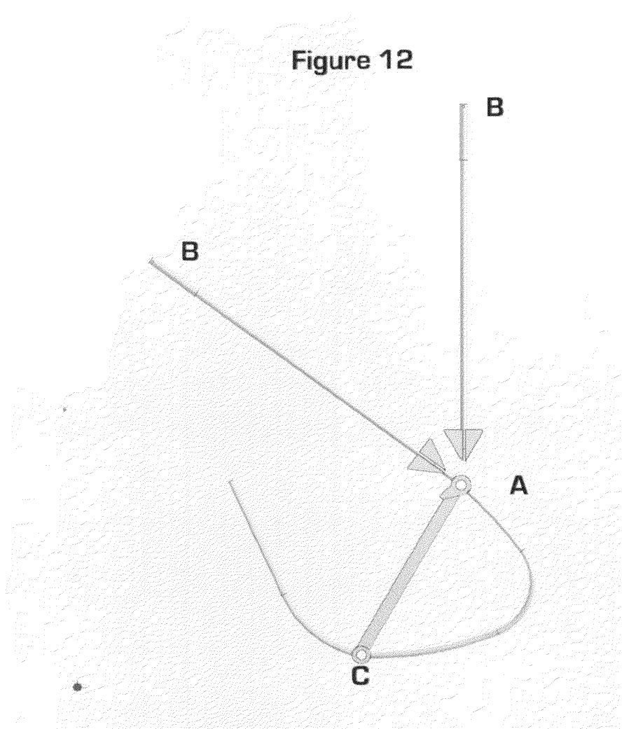

FIG. 12 shows the range of motion which adds to the reality of the simulation.
A. Pivot center.
B. Decoy Mount point.
C. Cable attachment point.

What is claimed is:

1. An improved interactive form decoy/platform system which is capable of realistically simulating the natural movements of a wild turkey and the many species named above, including simulated feeding, mating and normal behavioral activity, and physical movement of the decoy platform by a force control mechanism which can consist of a winder or a simple endpoint of a string or wire, between a range comprised of an (FIG. 2)(A) anchor point and a (B) anchor point which will allow for directional control as well as allowing the operator to simulate natural behavior such as feeding, mating ritual, distress, and many other aspects of animal behavior which add to the realism of the interaction. The platform assembly is unique in that it is of a tempered wire frame to provide suspension and can include a counter weighted junction box design to increase platform stability, which helps to facilitate realistic decoy actions and movement by increasing the range of motion. Additionally, the strategic location of the mounting point provides lift to the chassis and frame assembly, which reduces the force required to impart movement and smoothes the transitions of directional changes and adds to the realism of the simulation.

2. The decoy/platform system of claim one where the decoy mounting base is supported by a wire frame suspension that can extend at an angle of 45 degree forward for a specified length from the center of the platform base, then curves into an arc of 180 degrees then extends longitudal for a specified length, then curves into a specified decreasing radius curve of 120 degrees.

3. The decoy/platform system of claim one where the decoy mounting base is able to rotate through a range of 45 degrees from parallel to simulate feeding and mating activity, simulating natural game behavior.

4. The decoy/platform system of claim one wherein the decoy has the appearance of a wild turkey or a feeding hen.

5. The decoy/platform system of claim one wherein the decoy has the appearance of a Deer.

6. The decoy/platform system of claim one wherein the decoy has the appearance of a Hog.

7. The decoy/platform system of claim one wherein the decoy has the appearance of a Squirrel.

8. The decoy/platform system of claim one wherein the decoy has the appearance of a Prairie Dog.

9. The decoy/platform system of claim one wherein the decoy has the appearance of a Rat.

10. The decoy/platform system of claim one wherein the decoy has the appearance of a variety of varmint species.

11. The decoy/platform system of claim one, further comprising a retrieval mechanism for the remotely interactive behavioral simulation force controller.

12. The decoy/platform of claim one where the junction box can be fitted with different counterweighted masses to accommodate different game decoys of varying weight, mass, and height.

13. The apparatus set forth in claim 1 including a force control mechanism that provides impetuous as well as directional change and control.
